(19) United States
(12) Patent Application Publication
(10) Pub. No.: US 2018/0033105 A1
(43) Pub. Date: Feb. 1, 2018

(54) SYSTEM FOR INDUSTRIAL PROPERTY RIGHTS

(71) Applicant: Masataka TANAKA, Nagoya-shi (JP)

(72) Inventor: Masataka TANAKA, Nagoya-shi (JP)

(21) Appl. No.: 15/127,044

(22) PCT Filed: Oct. 22, 2015
(86) PCT No.: PCT/JP2015/079757

§ 371 Date: Sep. 19, 2016

(30) Foreign Application Priority Data
Feb. 12, 2015 (JP) JP2015-025885

(51) Int. Cl. G06Q 50/18; G06Q 30/08

(52) U.S. Cl. CPC G06Q 50/184; G06Q 30/08; G06Q 30/0641

(57) ABSTRACT

A server of the intellectual-property registration managing the intellectual-property information concerning the industrial-property rights that have been filed with the patent office by the applicant rights-holder. A terminal device of those persons wanting to use the industrial-property rights who have sent the bidding information applies the assignment or the license permission of the industrial-property rights. A terminal device of the rights-holder sends the 3D-form information in an ordered form that allows the forming means to produce the forms.

### TECHNICAL FIELD

This invention relates to a system for industrial property rights that allows for conveying a form or structure of an item or a combination thereof that forms an invention or an idea and/or allows for conveying the device of a design or the shape of a 3D trademark to be filed with the patent office.

### BACKGROUND ART

Today, in the midst of ongoing industrial globalization, the business activity of intellectual property rights (hereinafter referred to IPR) being secured by patent, trademark or copyright is growing increasingly important.

Especially, as the Trans Pacific Strategic Economic Partnership Agreement (TPP) is being concluded, discussions about the intellectual property of each nation is also reaching a conclusion, and it is not too much to say that the TPP will greatly affect Japan's status in the global market as an intellectual property power.

We occasionally come across various Internet web sites that widely deal with information of the above-referenced intellectual property secured by patent, trademark or copyright (hereinafter referred to as intellectual property information, for example, as shown in Patent Literatures 1 and 2 and in Non-patent Literature 1).

The intellectual-property-information-disclosure system, as shown in Non-patent Literature 1, allows us to see the intellectual-property information of which a unique analysis is made on various evaluation-figures of a promising market with future growth or ranking based on the publication of an application that is published by the patent office.

### CITATION LIST

### Patent Literature

Patent Literature 1: Japanese published and unexamined application No. 2014-089745
Patent Literature 2: Japanese published and unexamined application No. 2014-157219

### Non Patent Literature

Non-patent Literature 1: Astamuse Company, Ltd. Technical Information [online] of the Astamuse Company, Ltd. (as searched on Jul. 31, 2014). Internet website <URL: http://astamuse.com/ja/patent>

### SUMMARY OF INVENTION

### Technical Problem

In Japan, the above intellectual property rights and industrial property rights (as secured by patent, utility model, design and trademark) are administered by the patent office.

As for patent rights, the patent office set up a patent system for provisional exclusive licenses and provisional non-exclusive licenses (hereinafter referred to as the provisional-license system) so that the application rights (of a patent, utility model, design and trademark) that have been filed with the patent office can be actively used prior to the registration of such established rights.

As described above, the provisional-license system is already legally developed in Japan. The licensing of intellectual property applications that have not yet been registered as patents is to be legally set up.

In the case that a provisional license is granted, it might be difficult to obtain sufficient information about intellectual property secured by said provisional license, because although an application has been filed, said intellectual property has not yet been registered.

Although a provisional licensing system is now established, a practical and useable system is only now being developed. It seems that a scheme for encouraging more flexibility in using industrial and intellectual property rights that have already been applied for but not yet registered has not yet been fully established.

Regarding whether a particular patent right has been secured as an industrial property right, for instance, whether the application for said patent has already been filed or not is often likely to be learned only upon the publication of the application by the patent office.

In an exceptional case in which a request is filed for the early publication of an application, the fact of the application and of the content of the patent right and of the technology to be protected by said application should be known in advance. However, such a need for the early publication of an application is rare. Usually the technical content of the application or even of the fact of the application cannot be known before the publication date, which is 18 months after the application date, even if one searches the database of the patent office.

On the other hand, it might be more convenient for small and medium-sized enterprises and individual inventors in developing their sales channels if the technical content of their application is made known publically by having the information distributed.

In other words, if the intellectual-property information is publically known, then a third party will have more opportunity in learning of such information and so will become interested in learning more about the intellectual property, so that the inventor of the intellectual property is more likely to receive an offer from that third party for a license or to be asked by said third party to be assigned to receive such a license.

However, it is still difficult to reach persons efficiently who are interested in industrial intellectual property rights that have already been filed with the patent office (and to reach persons who hopefully will use such property rights by becoming a future assignee or licensee of a provisional license) simply by such industrial intellectual-property information being made known by the Internet.

It is a fact that small and medium-sized entrepreneurs and individual inventors want to find persons who are eager to use their industrial intellectual property immediately after an application for securing such rights to their property have been filed with the patent office, which will let such entrepreneurs and individual inventors raise necessary funds for developing their respective businesses so as to quickly prevent the inventive idea of their application that has been filed from being spoiled because of having to spend money on a application procedure on a limited budget.

Of the above point of view, small and medium-sized enterprises and individual investors want an operable system for securing their intellectual property rights that has an interactive buying-and-selling function that is especially available on an interactive-communications tool such as the Internet.

An interactive buying-and-selling function would not only provide information about the intellectual property of a patent application, but that a more advanced buying-and-selling function would allow for the exchange of more confidential information about that intellectual property than of information disclosed among creators and rights-holders of that intellectual property and of persons wanting to use such intellectual property rights by the Internet or the like and would enhance the negotiations of assignments and licensing.

The above “confidential intellectual-property information” (hereinafter referred to as “confidential intellectual-property information”) includes, for example, negative evaluations or views of the intellectual property that should not be disclosed to an unconcerned third party; includes know-how information and problems for technical development of the intellectual property; includes strategic information about the intellectual property for gaining predominance over competitors; includes future applications of the intellectual property and of future business developments; and includes other information and suggestions for developing or improving the invention by the current intellectual property.

As such, besides the function of providing information about the intellectual property, a buying-and-selling function would immediately allow the confirmation of the response of persons wanting to use such intellectual property rights that have already been applied for but not yet registered and would allow for proceeding with the negotiations for the assignment of such property rights or for a licensing agreement.

Patent Literature 2 shows a practical method for an interactive buying-and-selling function, paying attention to the exchange of confidential intellectual-property information during the negotiation of an assignment of the industrial property rights prior to the registration of a provisional-licensing agreement.

Even if information about the confidential intellectual property is secretive and important, it seems difficult for the applicant (rights-holder to the registration) to provide the correct image to persons wanting to use the invention of the patent application or the idea of a utility-model application that are the form and structure of articles or the combination thereof.

It is also difficult for an applicant rights-holder to describe the design or form or the 3D trademark that have been filed with the patent office to persons wanting to use them only by the exchange of information of the confidential intellectual property.

This invention was achieved in light of the foregoing problems with the aim of providing exact information about the forms and structures of the articles regarding a patent, utility model, design and the 3D trademark from an applicant rights-holder to persons wanting to use such rights.

### (The First Invention)

To solve the above-referenced problems, the first aspect of this invention refers to a system for industrial-property rights by having a server of the intellectual-property registration that is owned by the people except the patent office, and by having terminal devices of the rights-holders to such property rights and terminal devices of persons wanting to use the intellectual-property rights being connected to the server of intellectual-property registration by a public-communication network (the Internet); characterized in comprising

a server of the intellectual-property registration managing the intellectual-property information concerning the industrial-property rights that have been filed with the patent office by the applicant rights-holder;
a terminal device being used by an applicant rights-holder for attracting persons wanting the assignment of those industrial-property rights or an application for a licensing agreement;
a terminal device being used by persons wanting to use those industrial-property rights that have been filed with the patent office for assignment of the industrial-property rights or for a licensing agreement;
a terminal device for an evaluator who evaluates the value of those industrial-property rights that have been filed with the patent office; and a forming means for producing arbitrary 3D forms;
thereof such system the server of the intellectual-property registration has a structure for conducting processes for receiving the intellectual-property information directly from the terminal device of the rights-holder and for directly registering such intellectual-property information upon receiving the receipt together with the certified-application documents issued by the patent office;
for registering the evaluation of the value of the industrial-property rights that have been filed with the patent office holding the intellectual-property information; for providing to the terminal device of those persons wanting to utilize such industrial-property rights the intellectual-property information including the evaluation of value of such property rights;
for setting the contract of use in using the industrial-property rights that have been registered to the intellectual-property information (database) based on the information of the desired bid wanted by the rights-holder being sent from the terminal device of the rights-holder;
for receiving from the terminal device of persons wanting to use such property rights the bidding information (their bids) for the industrial-property rights of which the contract of use has been set;
for registering the confidential-intellectual property information given to the industrial-property rights that have been filed with the patent office by the terminal device of the rights-holder or by the terminal device of those persons wanting to use the industrial-property rights who have sent the bidding information (their bids);
for receiving the form and structure of the articles regarding the patent, utility model or design or 3D-form information regarding the 3D trademark, which has been filed with the patent office, from the terminal device of the rights-holder; for providing the terminal device of those persons wanting to use such rights who have sent the bidding information (their bids) with the 3D-form information in an ordered form that allows the forming means to produce the forms;
for automatically preparing the electronic-application document necessary to be submitted to the patent office for the assignment or license of the industrial-property rights, of which the contract of use has already been set, upon the bidding-application information (the bids) being received from the terminal devices of those persons wanting to use such property-rights meeting the condition of the contract of use; and
for allowing access to the electronic-application document prepared,
as above, by the terminal devices of those persons wanting to use such property rights who have sent the bidding-application information (their bids) that meets the condition of the contract of use.

The first aspect of this invention allows for obtaining the form or structure of a patent, utility model and design that have been filed with the patent office or for obtaining information about the 3D trademark (3D-form information) from the terminal device of the applicant rights-holder, thus providing (publishing) such information only to the terminal device of those persons participating in the bidding.

Hence, the above mentioned 3D-form information means the electronic data used in producing the form or structure of the article or 3D trademark by an actual “forming means” (such as a 3D printer, a Computer Numerically Controlled (CNC) lathe or the like) that is possible to be received by a public-communication network such as the Internet or the like.

As such, persons participating in the bidding for an assignment of the registered rights or provisional license agreement can realize (reproduce as the real thing) the form and structure of the patent, utility model, design or the 3D trademark that have been filed with the patent office by using the 3D-form information and “forming means” (such as a 3D printer, a CNC lathe or the like), thus enabling the applicant to convey the correct image of such registered rights to those persons wanting to use such rights.

Second Aspect of this Invention

To solve the above-mentioned problems, the second aspect of this invention refers to a system for industrial-property rights according to the first aspect of this invention characterized in comprising a structure for executing processes whereby the intellectual-property registration server receives an electronic certificate respectively from the terminal device of the rights-holder and from the terminal device of those persons wanting to use such property rights, and registering the data corresponding to the electronic certificate to the terminal device of the rights-holder and to the terminal device of those persons wanting to use such data.

The second aspect of this invention allows for eliminating as much as possible the possibility of impersonation by a malicious third party while the system is being used by a rights-holder and persons wanting to use the data of the rights-holder, thus making it possible to secure the identification of the applicant rights-holder and of those persons wanting to use such rights, thus avoiding a misappropriated change of name and disclosure of secrets regarding the right of the registration and of the provisional-exclusive license and of the provisional non-exclusive license and of the confidential intellectual-property information that are dealt by the system for the industrial-property rights.

### BRIEF DESCRIPTION OF DRAWINGS

FIG. 1 is a block diagram showing the whole construction of the system for the industrial-property rights regarding the embodiment of this invention.

FIG. 2 is a block diagram showing the electrical configuration of the server for the intellectual-property registration.

FIG. 3 shows an example of the data-structure of the intellectual-property information.

FIG. 4 shows an example of the data-structure of the user information.

FIG. 5 shows an example of the data-structure of the bidding information.

FIG. 6 shows the first example of the electronic document that is generated upon transferring the rights to be granted.

FIG. 7 shows the second example of the electronic document that is generated upon transferring the rights to be granted.

FIG. 8 shows the first example of the electronic document that is generated upon entering the provisional-licensing agreement.

FIG. 9 shows the second example of the electronic document that is generated upon entering the provisional-licensing agreement.

FIG. 10 is a block diagram showing the electrical configuration of the terminal device of the rights-holder.

FIG. 11 is a block diagram showing the electrical configuration of the terminal device of those persons wanting to use such rights.

FIG. 12 is a block diagram showing the electrical configuration of the terminal device of the evaluator.

FIG. 13 is a sequence diagram showing the behavior of the system for the industrial-property rights upon processing the object.

FIG. 14 is an example of the entry-screen for registering the intellectual property that is shown with the terminal device of the rights-holder.

FIG. 15 is an example of the entry-screen for the user registration that is shown with the terminal device of the rights-holder and of those persons wanting to use the intellectual-property information.

FIG. 16 is an example of the entry-screen for participating in the bidding that is shown with the terminal device of those persons wanting to use the intellectual-property information.

### DESCRIPTION OF EMBODIMENTS

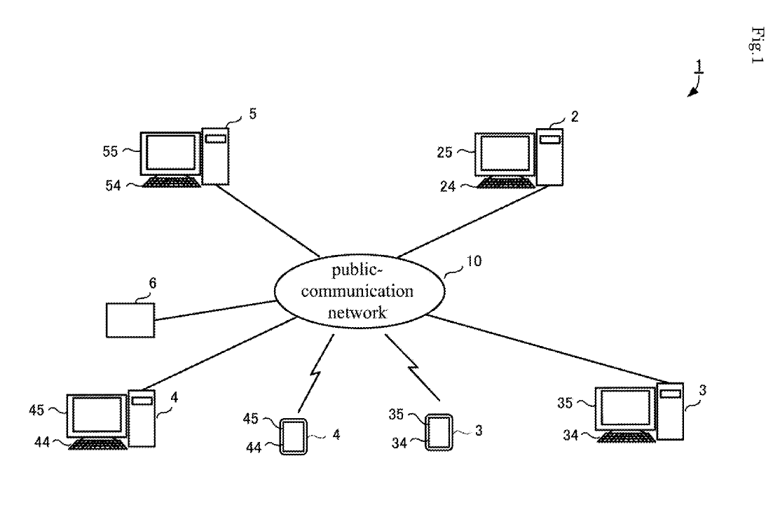

The system for the industrial-property rights of this invention will be described herein with reference to FIG. 1 to FIG. 16.

### Embodiment

The embodiment of this invention consists of the system 1 for efficiently utilizing the industrial-property rights (for an assignment or for a license agreement) that have been filed with the patent office but not yet registered.

FIG. 1 is a block diagram showing the system 1 for the industrial-property rights regarding the embodiment of this invention.

As shown in FIG. 1, the system 1 for the industrial-property rights is a system for connecting the server 2 of the intellectual-property registration that is owned by any person except by the patent office to the terminal device 3 of the rights-holder; to the terminal device 4 of those persons wanting to use the intellectual-property rights; to the terminal device 5 of the evaluator; and is a system comprising a forming means 6 being enabled by the public-communication network 10.

In using the public-communication network 10 such as the Internet or the like, the technology of Virtual Private Network (VPN) or the like will make it possible to maintain security at a higher level.

The system 1 of this invention comprises the server 2 for the intellectual property registration and for managing the intellectual-property information regarding the industrial-property rights that have been filed with the patent office by the applicant rights-holder; comprises the terminal device 3 owned by the applicant rights-holder and by those persons wanting use such rights and which is used in attracting persons who are seeking the assignment or license agreement of such rights; comprises the terminal device 4 of those persons wanting to use and to register as a user those industrial-property rights that have been filed with the patent office; comprises the terminal device 5 of the evaluator who evaluates the value of the industrial-property rights that have been filed with the patent office; and comprises the forming means 6 for producing the 3D-form of the articles.

The forming means 6 is a common device such as a 3D printer or a CNC lathe or the like for producing the arbitrary 3-D articles according to the instructions of the common device 6.

The server 2 of the intellectual-property registration (hereinafter referred to as “the intellectual property (IP) server” conducts the procedures for registering the IP information by receiving at the same time the IP information directly from the terminal device 3 of the rights-holder; by receiving the receipt (RC) issued by the patent office together with its certified application (AP) documents from the terminal device 3 of the rights-holder; by adding the evaluation of the value of the industrial-property rights that have been filed with the patent office; by receiving from the terminal device 5 the IP information; and by providing the IP information to the terminal device 4 of those persons wanting such information, including the above evaluation of the value of the IP.

The intellectual-property server 2 of this invention executes the processes for setting up the condition of contract in using the industrial-property rights that are registered in the intellectual-property information, based on the bidding information being sent from the terminal device 3 of the rights-holder to receive the bidding information of the industrial-property rights on which the condition of contract of use is set and based on the information being sent from the terminal device 4 of those persons wanting to use such information, and to register the confidential intellectual-property information that has been granted to the industrial property rights-holder and which has been filed and sent from the terminal device 3 of the rights-holder or from the terminal device 4 of those persons wanting such information, who have sent the bidding information to the intellectual property information database.

The intellectual-property server 2 also executes the processes for receiving the form or structure of the articles of the patent utility model or design that have been filed or of the 3D-form information of the 3D trademark from the terminal device 3 of the rights-holder and then executes the registration of such information to the intellectual-property information (database) and then receives the 3D-form information, thereby making it possible to provide the terminal device 4 of those persons wanting to use such property rights who have sent the bidding-application information (their bids) with the 3D-form information in an ordered form that allows the forming means 6 to produce the forms.

Furthermore, the intellectual-property server 2 of this invention is formed to execute the processes for preparing automatically the electronic documents necessary to be submitted to the Patent Office, which documents pertain to the assignment of the industrial-property rights or of the license agreement of which the condition of contract of use is set, and to allow the terminal device 4 of those persons who have already sent the bidding information that meets the requirement for the condition of contract of use to access the prepared electronic documents.

Hereinafter, the system is described in detail.

As shown in FIG. 1, the intellectual-property server 2 receives the intellectual-property information from the terminal device 3 upon identifying each rights-holder. Here, the term “intellectual-property information” means not only industrial-property rights that have been filed with the patent office but also those that have been filed with a foreign patent office.

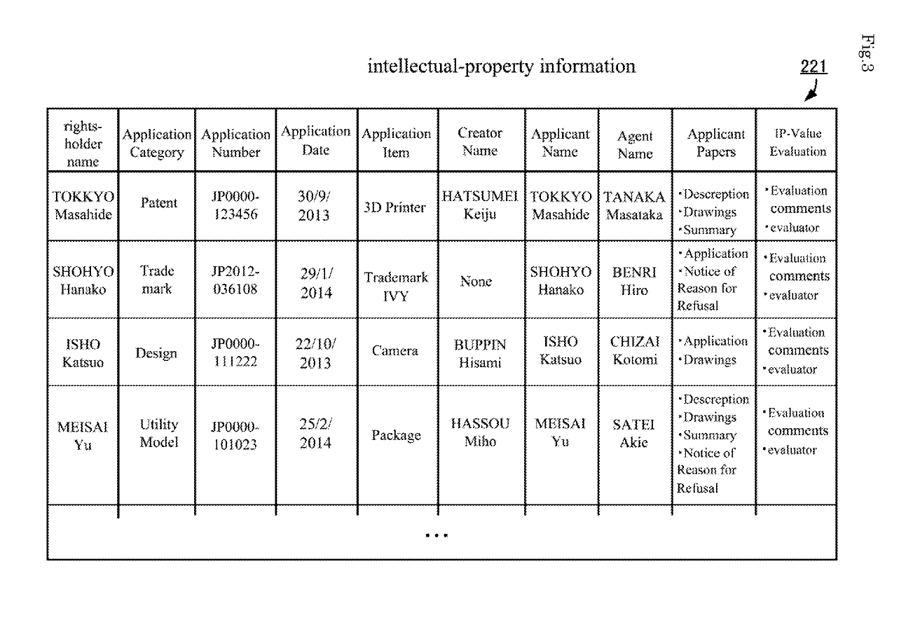

The aforementioned “intellectual-property information” (see FIG. 3) includes the following items:
1) Name of the rights-holder: The name of the person or organization that is qualified to register the industrial-property rights that have been filed with the patent office.
2) Application Category: The type of industrial-property rights regarding a patent, utility model, design or trademark that have been filed with the patent office.
3) Application number: The number that is allocated to the application by the patent office.
4) Application date: The filing date of the application with the patent office.
5) Application item: The title of the invention in the case of a patent application; the name of the idea in the case of a utility-model application; the article of the design in the case of a design application; the mark to be registered in the case of a trademark application.
6) Name of the creator: The name identifying the creator who has qualified for the protection of his rights (regarding a patent, utility model, design or the like) that have been filed with the patent office.
7) Applicant's name: The name identifying the person or organization that has filed the above application with the patent office.
8) Agent's name: The name identifying the attorneys (patent attorneys, patent professional organizations or the like) that attended to the filing of the above application.

The data-format of the above “intellectual-property information” is either a specified format such as the Comma Separated Value (CSV) format of which each item of data such as the application number, the title of the invention or the like is separated by a comma, or some other kind of data file that is in compliance with an arbitrary database.

Any arbitrary measure can be used in the “acquisition of electronic intellectual property-information data” by the server 2 that makes it possible to receive such information-data by an arbitrary communications circuit (for example, public-communication network 10) from the terminal device 3 of the rights-holder, and which makes it possible to read such information-data from an arbitrary data-storage media such as Digital Versatile Disks (DVD's) or the like or from removable transportable memory.

The terminal device 3 is an electronic device such as a cell-phone, a smartphone, a personal computer (PC) or tablet-like device or the like that is owned by the rights-holder who has filed his industrial-property rights with the patent office.

The terminal device 3 makes it possible to send the intellectual-property information including various the “industrial-property rights” that are owned and have been filed by the rights-holder, to the intellectual-property server 2 by the public-communications network 10.

The terminal device 3 of the rights-holder sends (1) the receipt RC issued by the patent office and (2) the application documents AP certified by the patent office (hereinafter referred to as “certified-electronic documents” to the intellectual-property registration server 2.

The industrial-property rights that have been filed with the patent office should be certified by the letter of “proof” that is given upon filing the electronic application with the patent office through the Internet.

As shown in FIG. 1, the intellectual-property server 2 receives the intellectual-property information from the terminal device 3 upon identifying each rights-holder.

Also, the intellectual-property server 2 receives both the receipt RC and the certified-application documents AP, thus recognizing that the user of the terminal device 3 is the legitimate applicant (qualified to register the industrial-property rights that have been filed), and thus registering the intellectual-property information being sent from the terminal device 3. The reason for this procedure is that there is no other way of verifying the documents RC and AP, since the application-information regarding the industrial-property rights has not yet been published by the patent office.

The electrical structure of the intellectual-property server 2, of the terminal device 3 of the rights-holder, of the terminal device 4 of those persons wanting to use such rights, and of the terminal device 5 of the evaluator is described herein.

The structure of the servers including the terminal devices 2, 3, 4 and 5 is similar to one another, although the level of computer processing and of memory capacity or the like of each device is different. As shown in FIG. 1, each device 2, 3, 4 and 5 comprises a liquid-crystal display and output parts 25, 35, 45 and 55 and includes a printer (not shown in the figure) or the like and comprises a main unit for executing the various arithmetic processes and includes a keyboard and input parts 24, 34, 44 and 54 and a mouse (not shown in the figure).

The main (computing) unit comprises a control function, namely, a central processing unit (CPU), a memory function, namely, a hard-disc drive (HDD), read-only memory (ROM) and random-access memory (RAM) or the like and a communications function or the like for transmitting and receiving various signals of information.

The server 2 for the intellectual-property registration is described herein.

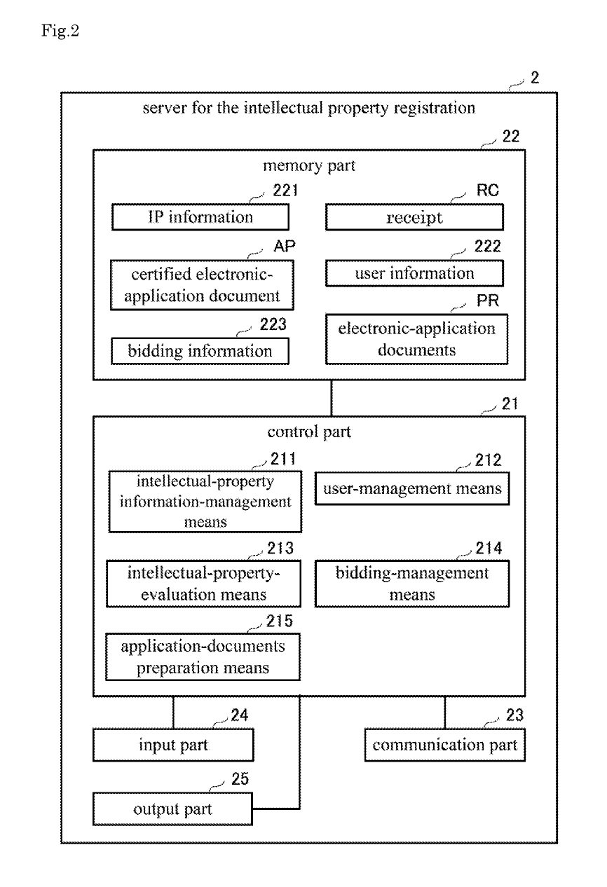

As shown in FIG. 2, the main (computing) unit of the intellectual property server 2 comprises a control part 21, namely, a CPU for executing arithmetic processing; a memory part 22, namely, the HDD, ROM, RAM or the like; and a communications part 23, namely, an input/output port (not shown in the figure) for channeling the various signals of information.

The communication part 23 is connected to the public-communication network 10 for receiving the intellectual-property information from the terminal device 3 of the rights-holder by the network 10. The communication part 23 includes a network-interface modem or the like.

The control part 21 comprises a CPU, ROM, RAM or the like and loads onto the RAM an application program stored in the ROM of the memory part 22 to execute the program, thus making it possible to realize the various logic means.

The intellectual-property server 2 then realizes the intellectual-property information-management means 211, the user-management means 212, the intellectual-property-evaluation means 213, the bidding-management means 214, and the application-documents preparation means 215.

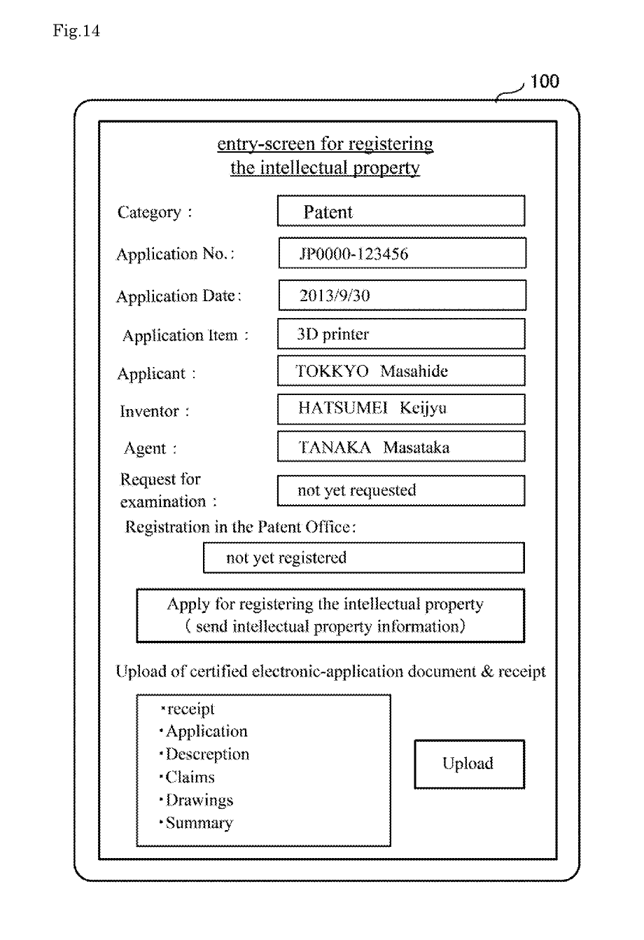

The intellectual-property information-management means 211 provides the terminal device 3 of the rights-holder with an intellectual-property (IP) registration screen 100 (see FIG. 14).

The management means 211 by the above registration screen 100 (FIG. 14) registers the intellectual-property information that is being transferred from the terminal device 3 of the right-holder to the memory part 22 and comprehensively manages such (IP) information 221 (see FIG. 3).

The IP information 221 as shown in FIG. 3 is information specifying the corresponding relationship between the industrial-property rights that have been filed with the patent office and the attribution of those relevant rights.

The IP information-management means 211 by the IP registration screen 100 (FIG. 14) associates the receipt RC and the certified-electronic document AP that is being sent from the terminal device 3 of the rights-holder with the IP information being sent from the terminal device 3 and then writes the RC and AP onto the memory part 22.

The above receipt RC is the receipt that was issued by the patent office upon filing the application for a patent with the patent office.

The certified electronic-document AP means the application document (in the case of a patent application, it contains the application, specification, claims, drawing and abstract) that was certified by the patent office. Also, the industrial-property rights that were filed with the patent office should be shown as having been certified by the letter of “proof” that was given upon filing the electronic application with the patent office through the Internet.

The IP information-management means 211 updates the IP information 221 upon the confidential-intellectual-property information being transferred from either the terminal device 3 of the rights-holder who is initiating the bidding or from the terminal device 4 of those persons wanting to bid.

The IP information-management means 211 receives from the terminal device 3 of the rights-holder the 3D-form information regarding the form and structure of the articles regarding the patent, utility model or the design and 3D trademark that have been filed with the patent office, thus registering such information to the IP information 221.

The bidding-management means 214 provides the 3D-form information to the terminal device 4 of those persons sending the bids.

The term “3D-form information” here means the design information indicating the structural drawing of the form and structure of the articles regarding the patent, utility model or design and the 3D trademark that have been filed with the patent office.

Of this embodiment, the 3D-form information is described in a form of order that makes it possible to convey the forming action to the forming means 6 (FIG. 1).

The first example of the 3D-form information is the electronic data for outputting by the 3D printer (forming means 6) the form and structure of the articles regarding the patent, utility model or design and the 3D trademark that were filed with the patent office.

The second example of the 3D-form information is the G-code for deleting the form and structure of the articles regarding the patent, utility model, design and the 3D trademark by using the CNC lathe (forming means 6).

The third example of the 3D-form information includes an augmented-reality (AR) marker in which the 3D image of the form, structure and 3D trademark are stored. In this case, taking the image of the 3D-form information by a camera on the terminal device 4 of those persons wanting such an image that can recognize the AR marker makes it possible to recognize the 3D image of the form and structure of the articles regarding the patent, utility model or design and the 3D trademark that have been filed.

The fourth example of the 3D-form information is the electronic data of the digital holography that realizes the 3D image by recording the fringe-pattern obtained by interfering the reflected light obtained by irradiating that light to the form, structure and 3D trademark with the light of the identical light-source onto an image sensor and then by processing the digital holography by the forming means 6.

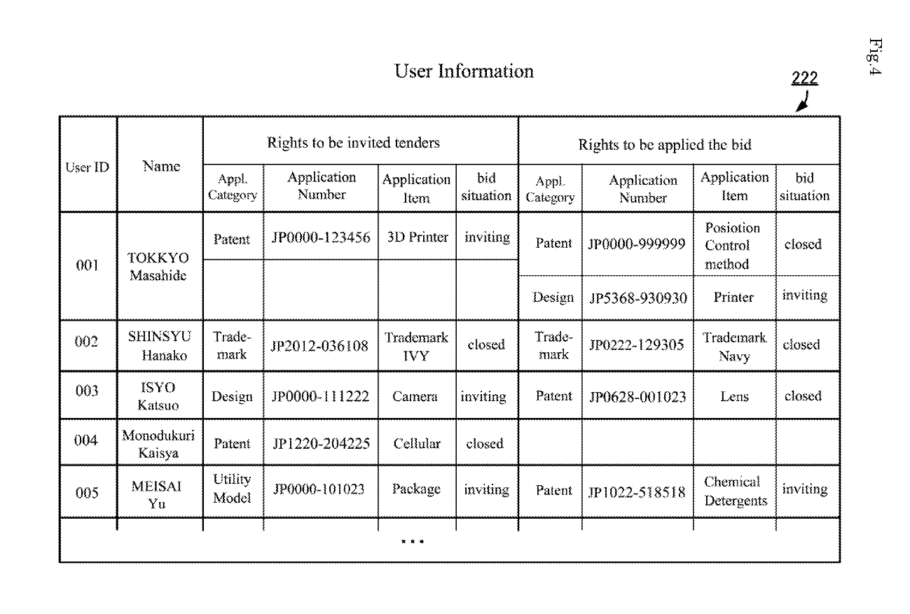

The user-management means 212 as shown in FIG. 2 allows for registering the user information that has been sent from the terminal device 3 of the rights-holder to the memory part 22, and allows for managing the entire user information 222 (see FIG. 4). Also, the user-management means 212 allows for deleting the registration data of the user from the user information 222 upon the user deleting his registration data.

The user information 222 is the information specifying the corresponding relationship between each user (the rights-holder and persons wanting to use such rights) using the system 1 and the attribution of the user. Regarding the user information 222 as shown in FIG. 4 the user ID identifying each user is associated with the bidding information of the rights being offered by each (rights-holder) user or is associated with the application information being offered by each (person wanting to use such rights) user.

The basic information of the user information includes the following items.
1) User ID: The unique identification information identifying the user of the system 1 for the industrial-property rights (i.e. of each rights-holder who has filed an application securing his industrial property rights or of those persons wanting to use such industrial property rights).
2) Name: The name of the person or organization of the rights-holder to whom the user ID is allocated or the name of those persons wanting to use the industrial-property rights.
3) Address: The address of the person using the system 1 for the industrial-property rights.
4) Telephone number: The telephone number of the person using the system 1 for the industrial-property rights.
5) The e-mail address of the person using the system 1 for the industrial-property rights.

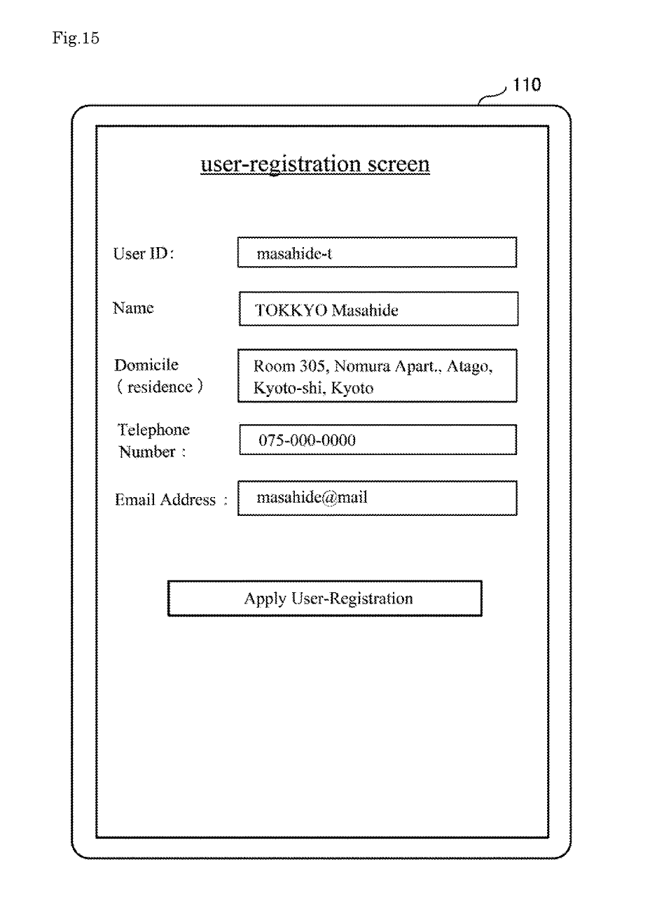

The user-management means 212 of the embodiment is to provide the terminal device 3 of the rights-holder or the terminal device 4 of a person wanting to use such rights with a user-registration screen 100 (see FIG. 15).

The system 1 deals with intangible rights for the registration of such rights and for the issuance of provisional exclusive licenses and provisional non-exclusive licenses that have a property value.

The system 1 allows too for the exchange of confidential intellectual-property information that should not be disclosed to an unconcerned third party.

It is preferable therefore to eliminate as much as possible the possibility of impersonation by a malicious third party while the system is being used by a rights-holder and by persons wanting to use the data of the rights-holder, and to secure the identification of the applicants (legitimate person holding the rights) and those persons wanting to use such rights.

In securing such identification, the practical user-management means 212 makes it possible to obtain the electronic certificate issued by a certifying authority from the terminal device 3 of each rights-holder of the intellectual property and from the terminal device 4 of each person wanting to use such intellectual-property rights, and to register the electronic certificate associated with the above user ID to the user information 222.

As shown in FIG. 2, the IP-evaluation means 213 is the means for evaluating the intellectual-property value of the industrial-property rights of which each rights-holder has filed with the patent office.

The term “evaluation of the intellectual-property value” here means the comprehensive evaluation of value including not only the technical-net value but the economic value in the business field wherein the industrial-property rights belong and the potential value including the growth potential in the future market of said business field.

The IP evaluation should be done by a patent attorney or another evaluator having a certain level of knowledge of the intellectual property and not done by a concerned person (the rights-holder or person wanting to use the IP information). The result of the IP evaluation is then to be transferred to the intellectual-property server 2 from the terminal device 5 of the evaluator.

Persons wanting to use the intellectual-property rights can negotiate with the rights-holder the appropriate price based on the evaluation of value, so that the trading price for handling, over the price of the industrial-property rights and of the license-agreement price, is close to the fair price, thus making it possible to avoid an unreasonably low trading price for the rights-holder, since the industrial-property right in question is not allowed by the patent office, yet the acquisition of such right is not assured.

The rights-holder should agree that the intellectual-property information being sent from the terminal device 3 of the rights-holder to the intellectual server 2 is to be disclosed to the evaluator.

The bidding-management means 214 is the means for setting the condition of contract for using the industrial-property rights that have been filed and for proceeding with the bidding to use such rights. The bidding modes include either an auction or individual negotiation with a specific party.

Of the embodiment of this invention, the bidding for the contract to use the industrial-property rights that have been filed shall be offered according to the bidding at an auction, which is one business practice.

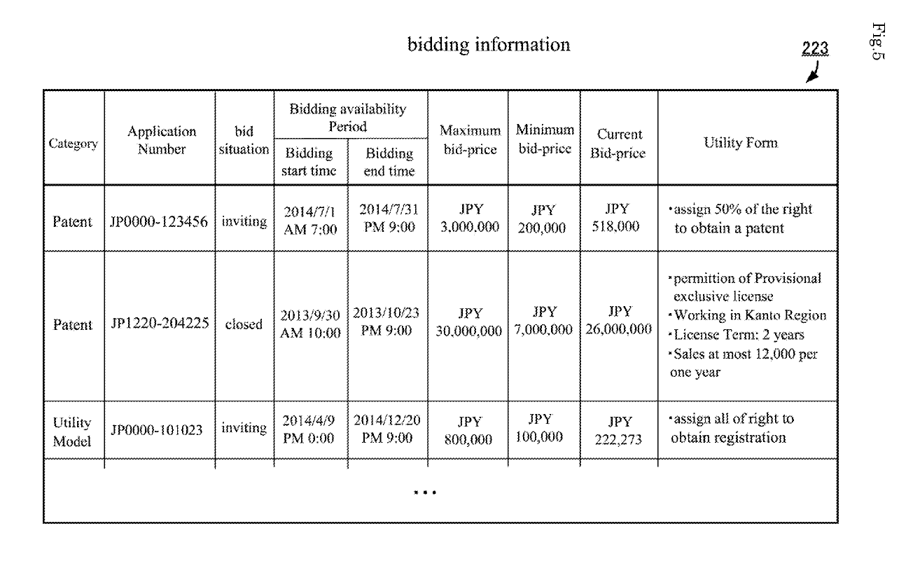

When the bidding information regarding the condition of contract for using the industrial-property rights that have been filed is transferred from the terminal device 3 of the rights-holder, the bidding-management means 214 writes the bidding information 223 (see FIG. 5) onto the memory part 22.

The condition of contract for using the industrial-property rights as shown in FIG. 5 sets the bidding-availability period (the date and time that the bidding is to start and end); sets the maximum bid-price and minimum bid-price; sets the current bid-price; and sets the utility-form (the full or partial assignment of the industrial-property rights or of the provisional exclusive license or provisional non-exclusive license of the industrial-property rights) of the desired contract (for the industrial-property rights).

The utility-form also includes the requirement for applicants who are allowed to exercise the industrial-property rights (the requirement for example of a business enterprise or of a sole proprietorship with capital of 300 million yen or less).

In the case that a provisional license is to be granted, it is preferable to set the condition of contract such as the time, region and quantity in using the provisional exclusive license of the industrial-property rights to encourage a person wanting to use such rights to agree willingly to the contract.

However, in the case that a provisional non-exclusive license is to be granted, it is preferable to specify whether it is a non-exclusive license agreement or an exclusive license agreement and to specify the number of persons allowed to use the license and the capital-capacity of such persons, since a provisional non-exclusive license allows for more than one person to use such a license.

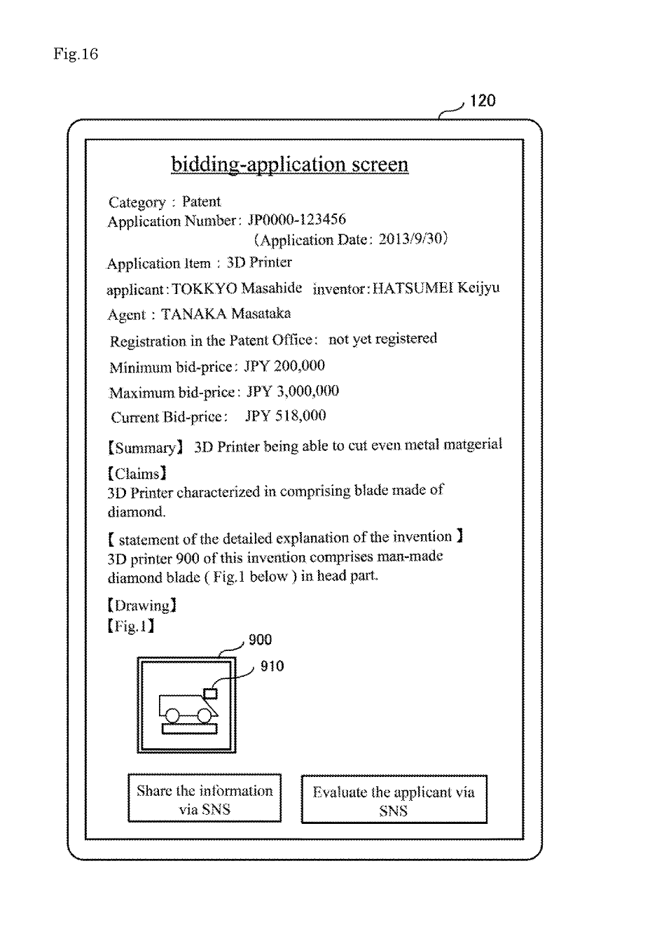

The bidding-management means 214 provides to the terminal device 4 of those persons wanting to participate in the bidding a bidding screen 120 (see FIG. 16) on which the condition of contract for utilizing the industry-property rights is extracted from the bidding information 223 that is being displayed.

The terminal device 4 transfers the bidding-application information to the intellectual-property server 2 by the bidding screen.

As shown in FIG. 2, the bidding-management means 214 identifies the terminal device 4 that meets the condition of contract of use (i.e. the bidding conditions) based on the application information (the bidding price and the desired license period or the like) being sent from the terminal device 4 of the person wanting to win the bid during the bidding period.

The bidding-management means 214 can provide the rights-holder (at the terminal device 3) with the bidding-application information by e-mail or by voice-mail or the like while such application-information is being sent by the above screen 120 (FIG. 16) from the terminal device 4 of those persons wanting to utilizing such rights.

The bidding-management means 214 can also automatically send a confirmation e-mail containing the transaction details of the bid to the terminal device 4 of the person who placed the order, so that the person wanting to use the property rights can avoid receiving an erroneous order.

The person meeting the above-mentioned condition of contract (bidding requirement) during the bidding-availability period will obtain the right to use the industrial-property rights (as a full or partial assignment if the registration rights or provisional exclusive/non-exclusive license agreements have been filed).

To hand over the right of registration (i.e. the change in name of the applicant) or of a provisional exclusive license, it is necessary to inform such a change in registration to the patent office. The application-document preparing means 215 then automatically prepares the electronic-application documents PR that are necessary to file with the patent office.

The electronic-application documents PR that have been automatically prepared are then submitted to the patent office by a patent attorney or by an agent of a patent-professional corporation or the like by online transfer or by regular mail.

It is a fact that certain information such as the personal name, organization name, address or domicile of the licensor and licensee are needed for the documents to be submitted to the patent office upon reporting the assignment of the right of registration or of a provisional-license agreement between them.

This invention makes it possible automatically to write such information in the form specified by the patent office based on the user information 222 (name of person or organization or address of such users or the like) that has been obtained at the time of the user registration of the system 1 for the industrial-property rights of this invention.

In other words, the application-document preparation means 215 prepares the electronic-application documents PR according to the “HTML electronic data that can be recognized by the electronic-filing software” of the patent office for the online procedure by the public-communication network 10.

As such, the documents PR are prepared in electronic-data form, thus making it possible to reduce the workload in preparing the documents.

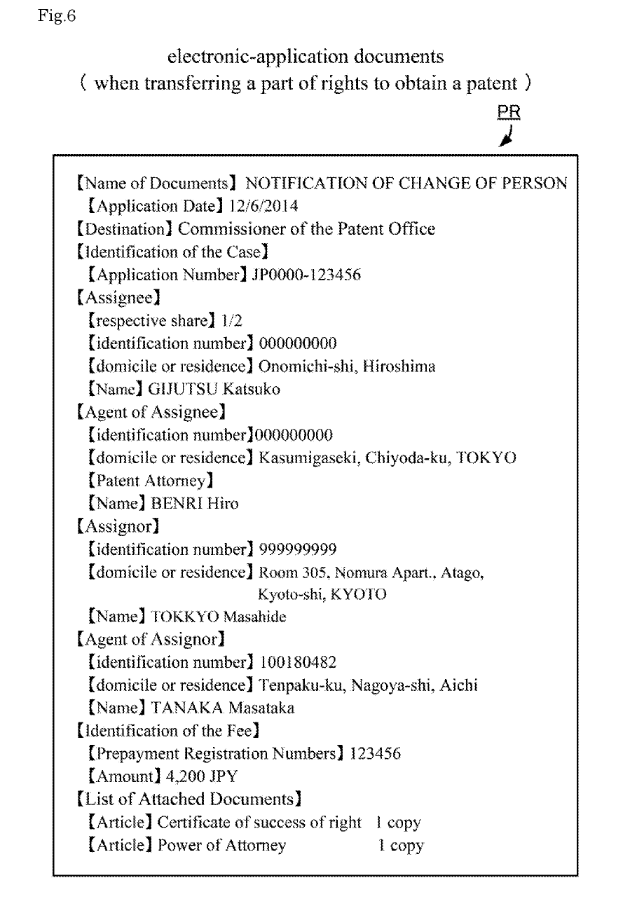

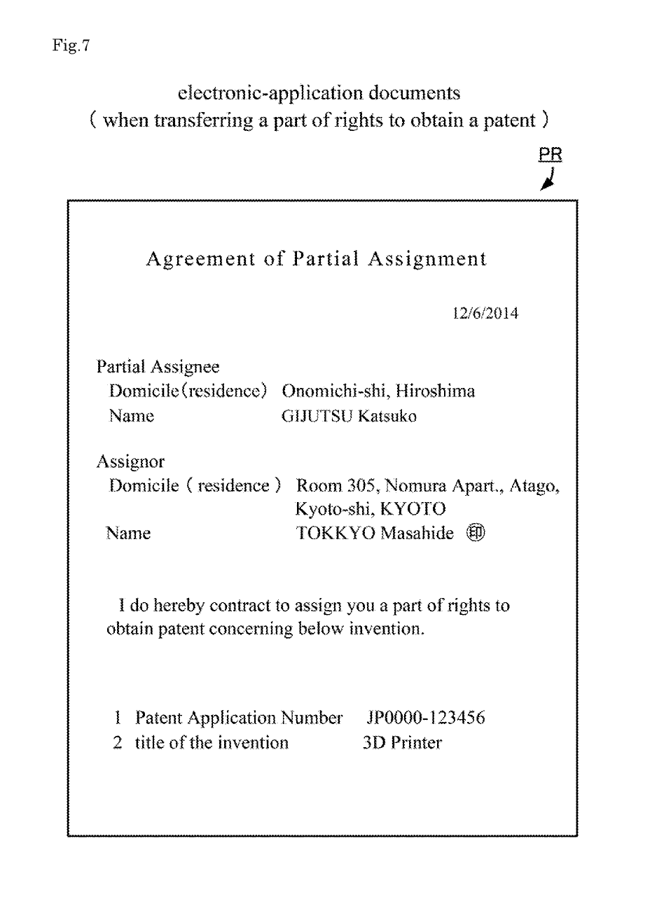

To assign a part of the right for obtaining a patent, the application-document preparation means 215 prepares the change-of-applicant's-name form as an electronic document PR (see FIG. 6) and as a partial-assignment document (see FIG. 7).

The change-of-name(applicant) form (FIG. 6) that is acceptable for online filing can be prepared in electronic form such as HTML electronic data or the like that is recognized by the electronic-filing software. On the other hand, the partial-assignment agreement (FIG. 7) that should be submitted in original form (i.e. as printed material) with a seal is prepared in a file format that is recognized by any word-processing software.

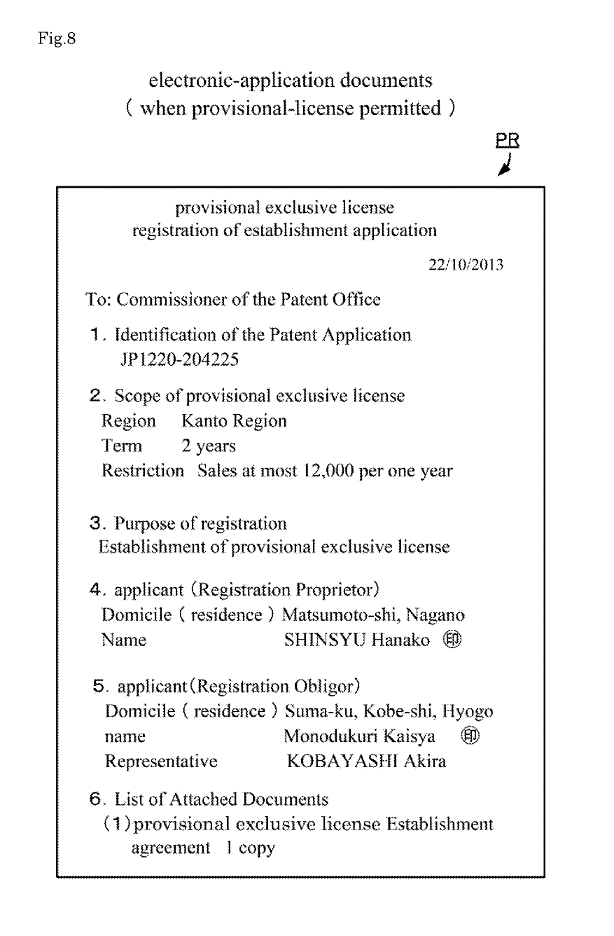

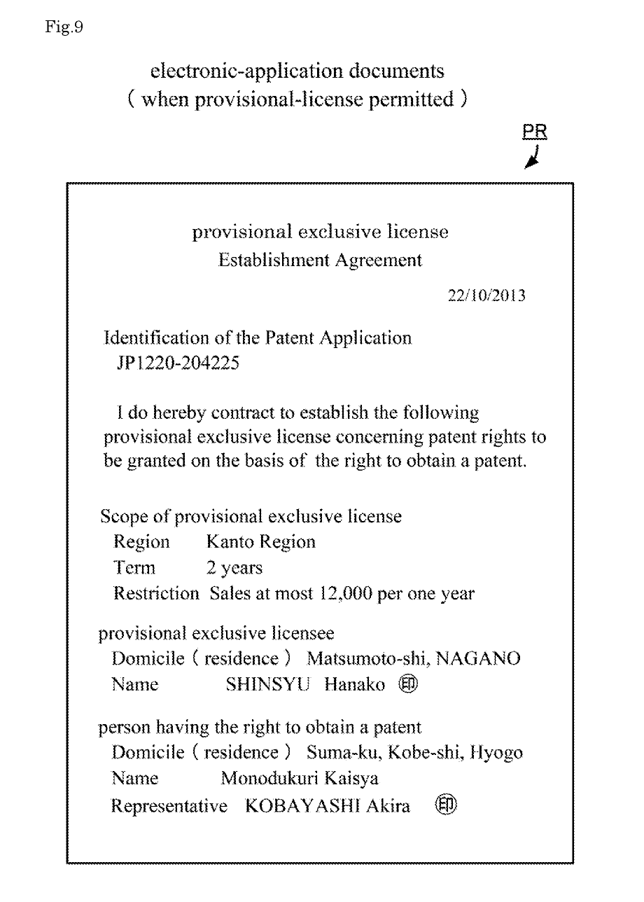

In the case that a provisional exclusive license is to be granted based on the right to obtain the patent, the application-document-preparation means 215 prepares the application form for registration of the provisional exclusive license (see FIG. 8) and for the agreement of the provisional exclusive license (see FIG. 9) as an electronic-application document PR.

The above two documents (the application form for the registration of a provisional exclusive license and the agreement for the provisional exclusive license) should be submitted in original (paper) form with a seal. Therefore, they should be prepared in a file format that can be read by any word-processing software.

The intellectual-property server 2 is connected to a printer (not shown in the figures) by a specific interface such as a connecting terminal or the like, i.e. a universal-serial bus (USB) or communication part 23, so that the application-document-preparation means 215 can print out the electronic-application document PR as printed material.

Regarding the printed materials of the application documents that must be submitted to the patent office: the assignment agreement (FIG. 7); the application form used in registering the provisional exclusive license (FIG. 8); and the agreement for the provisional exclusive license (FIG. 9), the system 1 of this invention automatically writes the necessary items (i.e. the name and domicile (residence) of the rights-holder who is permitting the use of his rights and the name and domicile (residence) of those persons wanting to use such rights) that must be entered in specific form, thus storing in the intellectual-property server 2 the electronic data (electronic document) in a state that can be printed out.

When the contract for use of the industrial-property rights is made between the rights-holder and those persons wanting to use such rights, the rights-holder must print out the assignment-document (i.e. the application form used in registering the provisional-exclusive license and the agreement for the provisional-exclusive license or the like) on paper and sign it and then send the original assignment-document to that person wanting to use it.

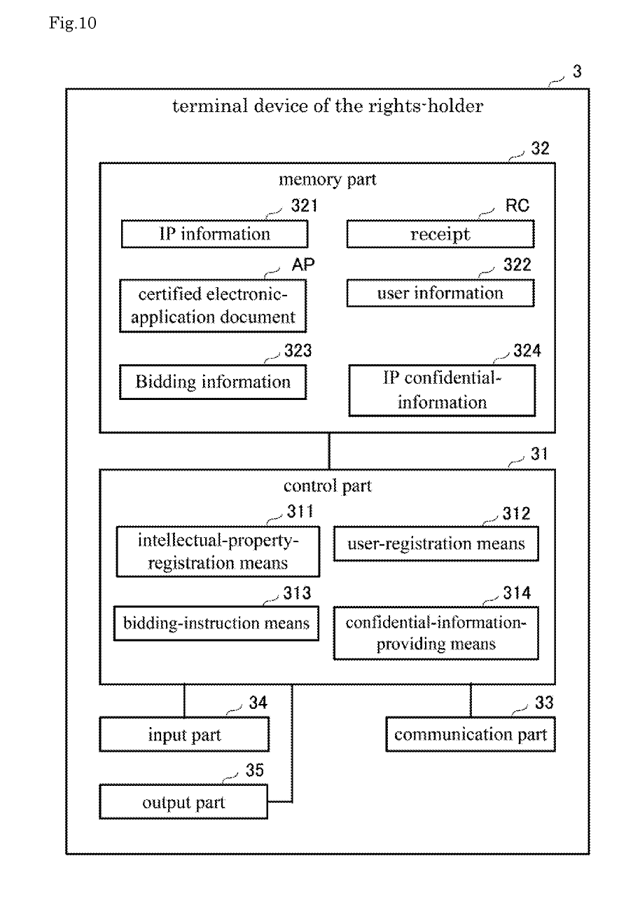

The structure of the terminal device 3 of the rights-holder is described herein. FIG. 10 is a block diagram showing the electrical configuration of the terminal device 3 of the rights-holder.

As shown in FIG. 10, the terminal device 3 of the rights-holder comprises the output part 35, namely, a liquefied-crystal display (LCD) or the like (not shown in the figures) and an input part 34, namely, a touch panel (not shown in the figures).

The terminal device 3 of the rights-holder comprises a control part 31, namely, the CPU for conducting the arbitrary arithmetic processing and a memory part 32, namely, a HDD, ROM and RAM or the like, and a communication part 33, namely, a communication port (not shown in the figures) as an input/output channel for conveying the various signals of information.

The communication part 33 allows for various communications with other devices by connecting them to the public-communication network 10 such as the Internet or a mobile-communication network or the like. The communication part 33 includes a network-interface modem or the like.

The control part 31 comprises a CPU, ROM and RAM or the like and loads onto the RAM an application program stored in the ROM of the memory part 32 to execute the program, thus making it possible to realize the various logic means.

The terminal device 3 of the rights-holder then realizes the intellectual-property information-registration means 311, the user-registration means 312, the bidding-instructions means 313, and the confidential-information-providing means 314.

The intellectual-property-registration means 311 is the means for applying the registration of the intellectual-property information to the intellectual property server 2.

The intellectual-property-registration means 311 of this invention makes it possible to apply for the user registration by sending to the intellectual property server 2 the intellectual-property information entered in the IP registration screen 100 (FIG. 14).

The term “intellectual-property information” here means intellectual property that has been filed with the patent office but not yet published by the patent office.

The IP registration-means 311 of the embodiment of this invention not only sends the intellectual-property information but also the receipt RC that was issued by the patent office at the time of filing and the certified electronic-application document AP to the intellectual-property server 2 by the registration screen 100 (FIG. 14).

A shown in FIG. 10, the user-registration means 312 is the means for applying for the user registration at the intellectual-property server 2. The means 312 makes it possible to apply for the user registration by sending to the intellectual-property server 2 the user information that has been entered by the user-registration screen 110 (FIG. 15).

Regarding the aforementioned application for the user registration, it is possible to use the user's account information (name, password or the like) that has been registered on a specific social-networking service (SNS) site such as Facebook®, as seen on a recent internet site, as the user information for the system 1 for the industrial-property information.

The user-registration means 312, upon applying for the user registration at the intellectual-property server 2, sends to the rights-holder the electronic certificate that was obtained by the certificating authority through its impartial examination.

The bidding-instruction means 313 is the means for offering the bid to the intellectual property server 2 regarding the condition of contract for using the industrial-property rights that have been filed.

The bidding-instruction means 313 makes it possible to invite bidding regarding the above condition of contract for using the intellectual-property rights by sending the bidding information entered by the input part 34 to the intellectual-property server 2.

The confidential-information-providing means 314 sends to the intellectual-property server 2 by the input part 34 the confidential intellectual-property information obtained by the rights-holder.

The confidential intellectual-property information includes for example negative evaluations or views of the intellectual property that should not be disclosed to an unconcerned third party; includes know-how information and problems for technical development of the intellectual property; includes strategic information for gaining predominance over competitors about the intellectual property; includes future applications of the intellectual property and future business developments; and includes suggestions for improving the invention to be developed by the current intellectual property.

The confidential-information-providing means 314 sends to the intellectual-property server 2 the forms and structures of the articles regarding a patent, utility model, design or the 3D-form information about the 3D trademark.

The structure of the terminal device 4 of those persons wanting to use the intellectual-property rights is described herein.

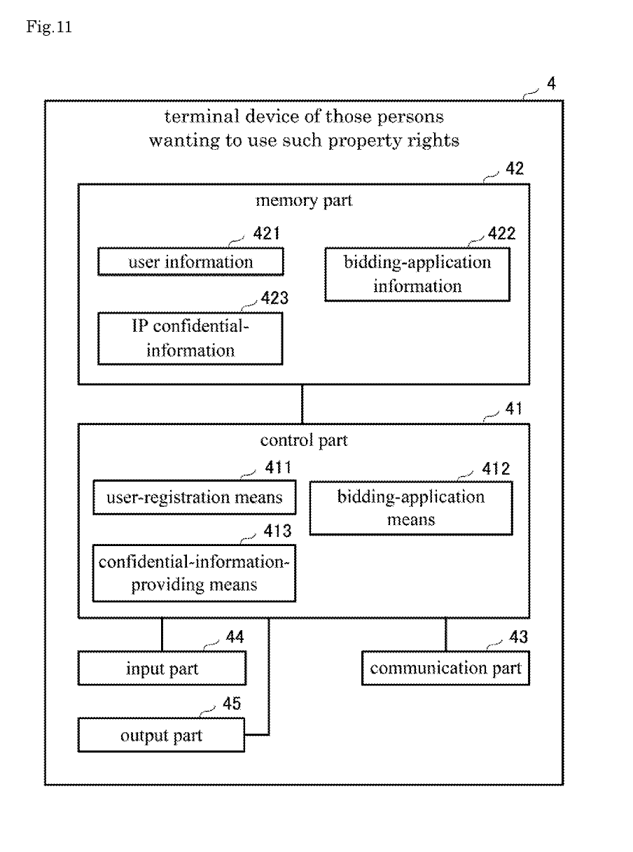

FIG. 11 is a block diagram showing the electrical configuration of the terminal device 4 of those persons wanting to use the rights.

The terminal device 4 of those persons wanting to use the rights comprises a control part 41, namely, a CPU for executing arithmetic processing, a memory part 42, namely, the HDD, ROM, RAM or the like, and a communication part 43, namely, an input/output port (not shown in the figure) for channeling the various signals of information.

The communication part 43 is connected to the public-communication network 10 such as the Internet, a mobile-communication network or the like, thus conducting various communications with other devices. The communication part 43 includes a network-interface modem or the like.

The terminal device 4 of those persons wanting to use the intellectual property rights is connected to the forming means 6 by a specific interface such as a universal-serial bus (USB) or the like or by the public-communication circuit 10.

The 3D-form information (in an order of format to the forming means 6) is sent to the means 6, thus making the forming means 6 produce the forms and structures of the articles regarding the patent, utility model, design or the 3D-form information about the 3D trademark.

The control part 41 comprises a CPU, ROM, RAM or the like and loads onto the RAM an application program stored in the ROM of the memory part 42 to execute the program, thus making it possible to realize the various logic means.

The terminal device 4 of those persons wanting to use the intellectual property then realizes the user-registration means 411, the bidding-application means 412, and the confidential-information-providing means 413.

The user-registration means 411 is the means for applying for the user-registration at the intellectual-property server 2.

The user-registration means 411 allows for the application of the user registration by sending to the intellectual-property server 2 the user information that is entered by the user-registration screen 110 (FIG. 15).

The user-registration means 411 at the time of applying for the user registration sends to the intellectual-property server 2 the electronic certificate that was issued by the certifying authority to those persons wanting to use the property rights.

As shown in FIG. 11, the bidding-application means 412 is the means for applying to the intellectual-property server 2 for participation in the bidding regarding the condition of contract for using the industrial-property rights that have been filed with the patent office.

The bidding-application means 412 allows qualified persons to participate in the bidding for the contract of use by sending to the intellectual-property server 2 their bidding-application-information (bidding price or the like) that is entered by the bidding-application screen 120 (see FIG. 16).

The bidding-application means 412, upon sending the application information (participating in the bidding), also allows for viewing by the public-communication network 10 the 3D-form information that has been registered at the intellectual-property server 2.

The confidential-information-providing means 413 is the means by the input part 44, for those persons wanting to use the property rights, to send the confidential industrial-property information that was filed with the patent office.

Of the embodiment of this invention, the confidential-information-providing means 413 can send the confidential intellectual-property information only if the bidding-application information has been sent to the intellectual-property server 2 by the bidding-application means 412.

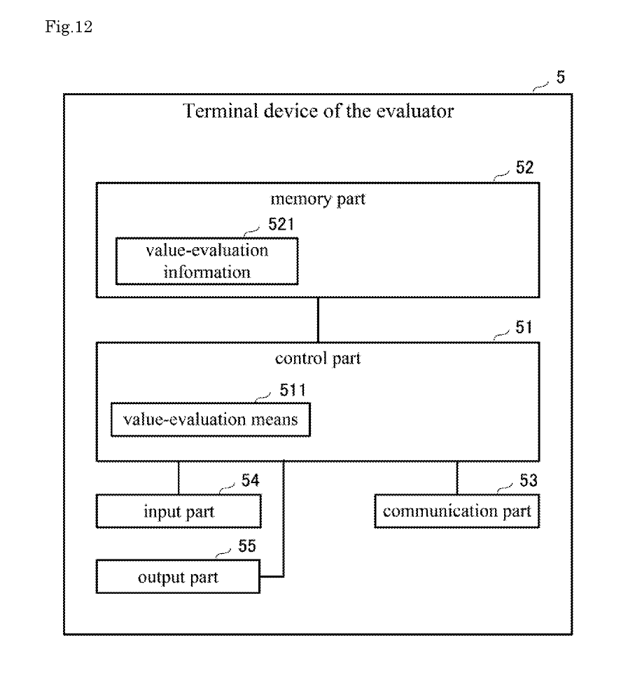

The structure of the terminal device 5 of the evaluators is described herein. FIG. 12 is a block diagram showing the electrical configuration of the terminal device 5 of the evaluator.

As shown in FIG. 12, the terminal device 5 of the evaluator comprises the output part 55 such as an LCD (not shown in the figures) or the like. The input part 54 includes a keyboard and touch panel (not shown in the figures).

The terminal device 5 of the evaluator comprises a control part 51, namely, a CPU for executing arithmetic processing; a memory part 52, namely, the HDD, ROM, RAM or the like; and a communication part 53, namely, an input/output port (not shown in the figure) for channeling the various signals of information.

The communication part 53 is connected to the public-communication network 10 such as the Internet, a mobile-telecommunication network or the like, thus conducting various communications with other devices. The communication part 53 includes a network-interface modem or the like.

The control part 51 comprises a CPU, ROM, RAM or the like and loads onto the RAM an application program stored in the ROM of the memory part 52 to execute the program, thus making it possible to realize the various logic means. The terminal device 5 of the evaluator then realizes the value-evaluation means 511.

The value-evaluation means 511 is the means for evaluating the value of the industrial-property rights that have been filed with the patent office and registered at the intellectual-property server 2.

A patent attorney or the like evaluates the value. The value-evaluation means 511 sends to the intellectual-property server 2 the evaluation-of-value information entered into the input part 54 by the evaluator.

The function-flow of the system 1 for using the industrial-property rights of this invention is described herein.

The rights-holder who is qualified in having the registration right to the industrial-property rights that have been filed accesses the IP registration screen 100 (FIG. 14) that is provided by the intellectual-property server 2.

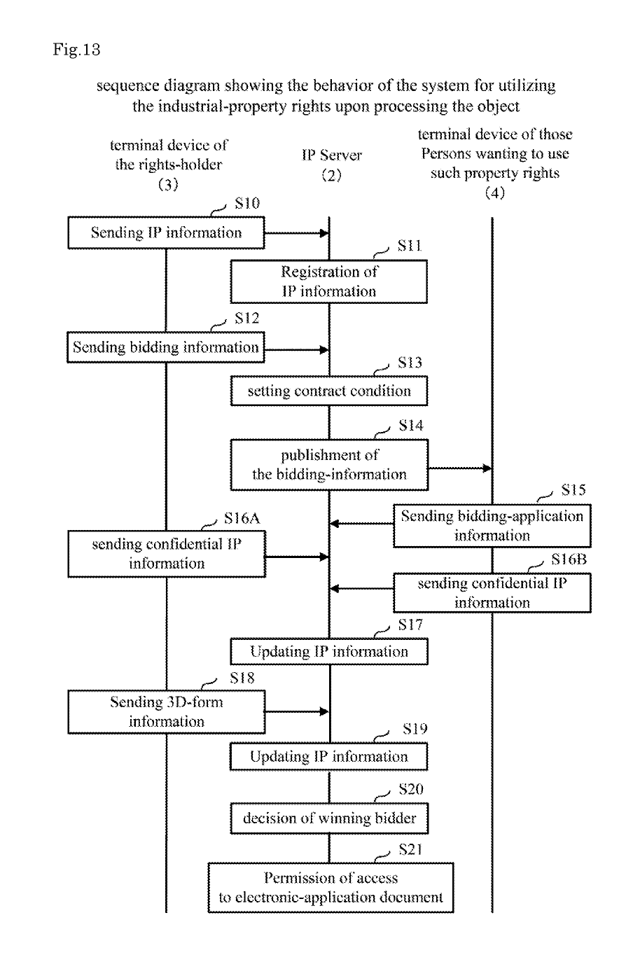

As shown in FIG. 13, the terminal device 3 of the rights-holder sends to the intellectual-property server 2 the intellectual-property information according to the information entered by the registration screen 100 by the rights-holder (Step S10). As such, the terminal device 3 applies for the registration of the intellectual property regarding the industrial-property rights that have been filed.

The terminal device 3 of the rights-holder sends to the intellectual-property server 2 not only the intellectual-property information by the intellectual property registration screen 100 but also the receipt RC that was issued by the patent office at the time of filing and also the certified-electronic document AP that was granted by the patent office.

The intellectual property server 2 upon receiving the intellectual-property information with the receipt RC and the certified-electronic document AP registers the intellectual-property information to the intellectual-property information 221 (see FIG. 3) onto the memory part 22 (Step S11). The receipt RC and the certified-application document AP are stored in said memory part 22 corresponding to the intellectual-property information 221.

To verify automatically the fact that the certified-electronic document AP was duly filed with the patent office, it is preferable to identify the letter of “proof” that is contained in the electronic document AP.

Of the embodiment of this invention, the rights-holder also accesses the user-registration screen 110 (FIG. 15) provided by the intellectual-property server 2 by using the terminal device 3 of the rights-holder.

The terminal device 3 of the rights-holder sends the user-information to the intellectual-property server 2 according to the information entered by the rights-holder to apply for the user registration and the intellectual-property registration. At the time of the user registration, the terminal device 3 sends the electronic documents of the rights-holder to the intellectual-property server 2.

After the bidding information is sent from the terminal 3 of the rights-holder (Step S12), the intellectual-property server 2 registers such bidding information 223 (FIG. 5) onto the memory part 22 and then sets the contract condition for using the industrial-property rights that have been filed based on the information 223 (Step S13).

As part of the contract condition of use, the period of bidding availability (the date and time that the bidding starts and ends) is specified. The intellectual-property server 2 publishes the bidding-information 223 at the start of the bidding availability period, thus starting the bidding regarding the industrial-property rights that have been filed (Step S14).

Those persons wanting to use the industrial-property rights that have been filed with the patent office and are registered at the intellectual-property server 2 should complete the user registration by accessing the user-registration screen 110 of the terminal 4 of those persons wanting to use such industrial-property rights.

At the start of the bidding, the bidding-application information including the bids is sent from the terminal device 4 of those persons wanting to use the rights (Step S15). The intellectual-property server 2 then updates the information of the current bid-price that is registered in the bidding-information 223 (FIG. 5) according to the bid-price contained in the bidding-application information.

The system 1 for the industrial-property rights of this invention allows for interactive buying-and-selling functions that are realized only by interactive communication by the public-communication network 10 (i.e. the Internet).

Specifically, it is possible at the same time to send from the terminal device 3 of the rights-holder offering the contract for his industrial-property rights that have been filed with the patent office (Step S16A) while the confidential intellectual-property information is being sent to the terminal device 4 of the those persons wanting to use those property rights. As the application information is being sent from the terminal device 4, the further confidential intellectual-property information can be sent to the terminal device 3 of the rights-holder (Step S16B).

As the confidential intellectual-property information is being sent either to the terminal device 3 of the rights-holder or to the terminal device 4 of those persons wanting to use his property rights, the intellectual-property server 2 updates the intellectual-property information 221 according to such confidential information (Step S17).

The terminal device 3 of the rights-holder sends the form and structure of the articles in connection with the patent, utility model, design or the 3D-form information of the 3D trademark to the intellectual-property server 2 when the bidding is associated with the form and structure of the articles of the patent and utility model that have been filed or with the design and 3D trademark that have been filed (Step S18).

The server 2 at the same time registers and updates the intellectual-property information 221 according to the 3D-form information (Step S19) and provides the terminal device 4 of those persons wanting to use the property rights with the 3D-form information (publication).

The terminal device 4 of those persons wanting to use the intellectual-property rights is connected to the forming means 6 by a specific interface such as a universal-serial bus (USB) or the like or to the public-communication network 10. The 3D-form information (in an order of format to the forming means 6) is then sent to the forming means 6, thus making the forming means 6 produce the forms and structures of the articles regarding the patent, utility model, design or the 3D-form information about the 3D trademark.

The intellectual-property server 2 verifies whether the bidding-availability period is over or not by monitoring the closing date and time of the bidding.

When the bidding-availability period has expired, the intellectual-property server 2 identifies the terminal device 4 of the person having met the contract condition for using the industrial-property rights that have been filed and identifies that person from among the terminal devices 4 of all persons who had sent bidding-application information during the bidding period and then finally decides the winning bidder (Step S20).

To hand over the industrial-property rights or the provisional exclusive license, it is necessary to inform the patent office of such conveyance. Therefore, the intellectual-property server 2 automatically prepares the electronic-application documents PR that are necessary to be filed with the patent office.

Of this embodiment, the form specified by the patent office is automatically filled out based on the user information 222 (FIG. 4) that was obtained at the time of the user registration by the system 1 for using the industrial property rights. Thus, the above document PR is prepared.

The intellectual-property server 2 also allows the terminal device 4 of that person having met the condition for using the intellectual property to access the downloadable electronic-application document PR that has been automatically prepared (Step S21).

The document PR downloaded by the terminal device 4 of the person having qualified to access it is to be submitted by the qualified person himself or by a patent attorney or by an agent of a patent professional corporation.

As described above, the system for using the industrial-property rights of this invention allows for the terminal device 3 of the rights-holder (applicant of the patent or the like) to provide the terminal device 4 of persons applying for participation in the bidding with the 3D-form information regarding the use of the industrial-property rights (i.e. the assignment of the registration right or of the provisional license) that have been filed.

The terminal device 4 of persons wanting to use the property rights can realize the form and structure of the articles in connection with the patent, utility model, design or the 3D trademark that have been filed by using the 3D-form information and the forming means 6 (i.e. 3D printer, CNC lathe or the like).

Therefore, when proceeding with the negotiation for using the industrial-property rights that have been filed, it is possible to convey the correct image of the forms and structures of the articles in connection with the patent, utility model, design or the 3D trademark that have been filed without providing those persons wanting to use such property rights with the real articles of the rights-holder (the applicant of the patent or the like).

The system for the industrial-property rights makes it possible to add the various characteristic functions of this invention simply by installing special application software to the arbitrary multi-functional electronic devices, thus making it possible to configure the above terminal device 3 of the rights-holder; the terminal device 4 of those persons wanting to use such rights; and the terminal device 5 of the evaluator.

A multi-functional electronic device preferably is a smartphone, a tablet-like device or a PC or the like. Although the CPU's of such electronic devices take an excessive load upon viewing intellectual-property information, the processing-capacity of such devices is constantly and tremendously being improved today to realize fast operational speeds for such processing.

A mobile-type multi-functional electronic device enables a rights-holder or a person wanting to use his rights to proceed easily with the negotiation at any time convenient.

As such, a multi-functional electronic device can be used as the terminal device 3 of a rights-holder; as the terminal device 4 of a person wanting to use such rights; and as the terminal device 5 of an evaluator, thus making it easier for a rights-holder willing to assign his rights or license that have been filed and easier for a person wanting to obtain those rights or license, and easier for an evaluator evaluating the value of those industrial-property rights to widen the range of using the system 1 by increasing the opportunity for persons to become aware of such industrial-property rights (i.e. the opportunity in viewing the property-rights information), thus realizing more flexibility in the use of industrial and intellectual property rights that have already been filed with the patent office.

The embodiments of this invention that are described above are not limited to them. Any structure or detail that is well known to someone skilled in the ART OF THIS INVENTION MAY BE CHANGED, SO LONG AS SUCH A CHANGE DOES NOT deviate from the main subject of this invention.

### REFERENCE SIGNS LIST

1. System for the industrial property rights
2. Intellectual property (IP) registration server
3. Terminal device of rights-holder
4. Terminal device of persons wanting to use the intellectual property rights
5. Terminal device of evaluators
6. Forming means
10. Public communication network

1. A system for industrial-property rights by having a server of the intellectual-property registration that is owned by the people except the patent office, and by having terminal devices of the rights-holders to such intellectual-property rights and terminal devices of persons wanting to use the intellectual-property rights being connected to the server of intellectual-property registration by a public-communication network (the Internet);
characterized in comprising
a server of the intellectual-property registration managing the intellectual-property information concerning the industrial-property rights that have been filed with the patent office by the applicant rights-holder;
a terminal device being used by an applicant rights-holder for attracting persons wanting the assignment of those industrial-property rights or an application for a licensing agreement;
a terminal device being used by persons wanting to use those industrial-property rights that have been filed with the patent office for assignment of the industrial-property rights or for a licensing agreement;
a terminal device for an evaluator who evaluates the value of those industrial-property rights that have been filed with the patent office; and
a forming means for producing arbitrary 3D forms;
thereof such system the server of the intellectual-property registration has a structure for conducting processes for receiving the intellectual-property information directly from the terminal device of the rights-holder and for directly registering such intellectual-property information upon receiving the receipt together with the certified-application documents issued by the patent office;
for registering the evaluation of the value of the industrial-property rights that have been filed with the patent office holding the intellectual-property information; for providing to the terminal device of those persons wanting to utilize such industrial-property rights the intellectual-property information including the evaluation of value of such property rights;
for setting the contract of use in using the industrial-property rights that have been registered to the intellectual-property information (database) based on the information of the desired bid wanted by the rights-holder being sent from the terminal device of the rights-holder;
for receiving from the terminal device of persons wanting to use such property rights the bidding information (their bids) for the industrial-property rights of which the contract of use has been set;
for registering the confidential-intellectual property information given to the industrial-property rights that have been filed with the patent office by the terminal device of the rights-holder or by the terminal device of those persons wanting to use the industrial-property rights who have sent the bidding information (their bids);
for receiving the form and structure of the articles regarding the patent, utility model or design or 3D-form information regarding the 3D trademark, which has been filed with the patent office, from the terminal device of the rights-holder; for providing the terminal device of those persons wanting to use such rights who have sent the bidding information (their bids) with the 3D-form information in an ordered form that allows the forming means to produce the forms;
for automatically preparing the electronic-application document necessary to be submitted to the patent office for the assignment or license of the industrial-property rights, of which the contract of use has already been set, upon the bidding-application information (the bids) being received from the terminal devices of those persons wanting to use such property-rights meeting the condition of the contract of use; and
for allowing access to the electronic-application document prepared,
as above, by the terminal device of those persons wanting to use such property rights who have sent the bidding-application information (their bids) that meets the condition of the contract of use.

2. A system for industrial-property rights according to the first aspect of this invention characterized in comprising a structure for executing processes whereby the intellectual-property registration server receives an electronic certificate respectively from the terminal device of the rights-holder and from the terminal device of those persons wanting to use such property rights, and for registering the data corresponding to the electronic certificate to the terminal device of the rights-holder and to the terminal device of those persons wanting to use such data.
